(19) United States
(12) Patent Application Publication
(10) Pub. No.: US 2014/0354289 A1
(43) Pub. Date: Dec. 4, 2014

(54) METHOD FOR PREDICTING CHARGING TIME OF BATTERY FOR ELECTRIC VEHICLE

(71) Applicants: KIA MOTORS CORPORATION, Seoul (KR); HYUNDAI MOTOR COMPANY, Seoul (KR)

(72) Inventors: Dong Il KIM, Gwangyang-si (KR); Woo Sung KIM, Hwaseong-si (KR); Dong Gil HA, Changwon-si (KR)

(73) Assignees: KIA MOTORS CORPORATION, Seoul (KR); HYUNDAI MOTOR COMPANY, Seoul (KR)

(21) Appl. No.: 14/015,558

(22) Filed: Aug. 30, 2013

(30) Foreign Application Priority Data
May 30, 2013 (KR) 10-2013-0061611

(51) Int. Cl. B60L 11/18

(52) U.S. Cl. CPC B60L 11/1861
USPC 324/426

(57) ABSTRACT

A method for predicting charging time of a battery for an electric vehicle is provided. The method includes differentiating a rapid charging and a slow charging. A necessary charging amount of the battery is calculated, and a reference current value that is stored in advance is detected for slow charging. A time required for slowly charging a battery is calculated using the necessary charging amount and the reference current value.

### CROSS-REFERENCE TO RELATED APPLICATION

This application claims under 35 U.S.C. §119(a), priority to Korean Patent Application No. 10-2013-0061611 filed on May 30, 2013, the entire contents of which are incorporated herein by reference.

### TECHNICAL FIELD

The present disclosure relates to a method for predicting a charging time of a battery for an electric vehicle, and more specifically, to a method for predicting a charging time of a battery for an electric vehicle, capable of predicting the charging time by differentiating a charging logic in accordance with charging types such as rapid charging or slow charging, etc., wherein estimated data through previous charging is used in case of slow charging, and map data prepared in advance is used in case of rapid charging.

### BACKGROUND

Generally, a separate battery having large capacity is used for generating power in a hybrid vehicle or an Electric Vehicle (EV), in addition to a battery having a small capacity used in an internal combustion engine. These batteries for a hybrid of EV have to be charged to stably drive the vehicle.

However, a battery generally requires a longer time to be charged, approximately 20 minutes (rapid charging) and up to 5 hours (slow charging), compared to the gasoline filling time of a gasoline vehicle.

For a hybrid vehicle or an EV, charging time of a battery is relatively long, and thus, it may be important for a driver to know the charging time in advance in case the battery is charged slowly at home or rapidly at a battery charging station.

The charging time has been calculated for this purpose simply using a constant current value and a necessary charging amount.

However, the calculated charging time of a battery may significantly deviate from the actual charging time due to variation of the charging current and a calculation error of the state of charge (SOC). As a result, a driver obtains an inaccurate predicted charging time of the battery.

The disclosed information in this background section is only for enhancement of understanding of the background of the disclosure and should not be taken as an acknowledgement that the disclosed information forms the prior art already known to a person skilled in the art.

### SUMMARY

The present disclosure has been made in an effort to solve the above-described problems associated with the prior art. The present disclosure provides a method for predicting a charging time of a battery for an electric vehicle, in which the different logics are performed in accordance with charging conditions. In case of slow charging, the current value when charging a battery is stored to be used in predicting the next charging time, and in case of rapid charging, the charging time to be predicted is calculated through a data map prepared in advance.

According to an exemplary embodiment of the present disclosure, a method for predicting a charging time of a battery for an electric vehicle includes: differentiating a rapid charging and a slow charging. A necessary charging amount of a battery is calculated, and a reference current value that is stored in advance is detected for slow charging. A time required for slowly charging a battery using the necessary charging amount and the reference current value is calculated.

The differentiating step may differentiate rapid charging and the slow charging using different signals that are received when a charging connector contacts a vehicle.

The necessary charging amount of a battery may be estimated by calculating the difference between a total capacity of the battery and a capacity of the battery corresponding to a state of charge (SOC).

The time required for slowly charging the battery may be calculated by dividing the necessary charging amount by the current value of a previous charging.

The method for predicting a charging time of a battery for an electric vehicle may further include a renewing step of storing the currently charging current value and renewing the existing reference current value with the currently charging current value, when the currently charging current values of average current values that are detected during charging are calculated, and the calculated currently charging current values are out of a set range while charging a battery after the calculation step of predicting slowly charging time of a battery.

The renewing step may not be performed if time required for charging a vehicle is within a range of set time.

The method for predicting a charging time of a battery for an electric vehicle may further include a step of calculating the time required for rapidly charging the battery by detecting and inputting an initial temperature and initial SOC information of the battery to a set map data for the rapid charging at the differentiating step. The detecting step and the calculating step to predict slowly charging time of the battery may be performed when the detected initial temperature of the battery is not included within a range of temperature stored in the map data.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limited.

FIG. 1 is a flow chart showing a method for predicting charging time of a battery for an electric vehicle according to an embodiment of the present disclosure.

FIG. 2 is a flow chart showing renewing procedures of reference current value according to an embodiment of the present disclosure.

### DETAILED DESCRIPTION

Hereinafter, a prediction system and method of charging time of a battery for an electric vehicle according to an exemplary embodiment of the present disclosure will be described, referring to the accompanying drawings.

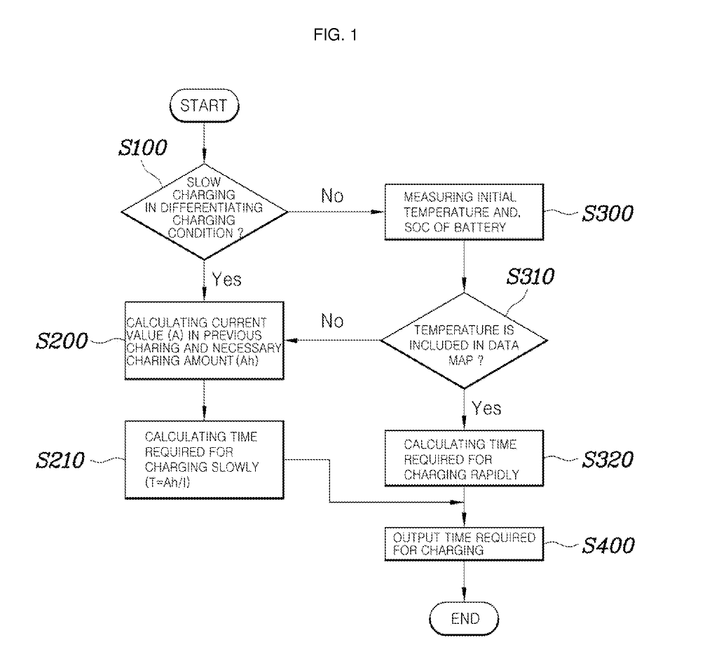

FIG. 1 is a flow chart showing a method for predicting a charging time of a battery for an electric vehicle according to an embodiment of the present disclosure wherein the method includes steps of: differentiating a rapid charging and a slow charging, S100; calculating a necessary charging amount of a battery and detecting a reference current value that is stored in advance for slow charging, S200; and calculating to predict the time required for slowly charging a battery using the necessary charging amount and the reference current value S210.

In more detail, the differentiating step S100 can differentiate rapid charging and slow charging using different signals received when a charging connector contacts a vehicle. The rapid charging or the slow charging may be differentiated with contact portions of the charging connectors that are shaped differently, or by a driver who directly selects the charging modes thereof through a controller. The rapid charging and the slow charging may be selected by various ways, in addition to the methods, as described above.

For the slow charging in the differentiating step S100, the detecting step S200 calculates the necessary charging amount of a battery and detects the reference current value that is stored in advance.

Here, the necessary charging amount of a battery refers to a current amount necessary for fully charging a battery which is estimated by calculating the difference between a total capacity of the battery, that is a current amount when the battery is charged fully, and a capacity of the battery corresponding to SOC thereof, that is the currently remaining current amount.

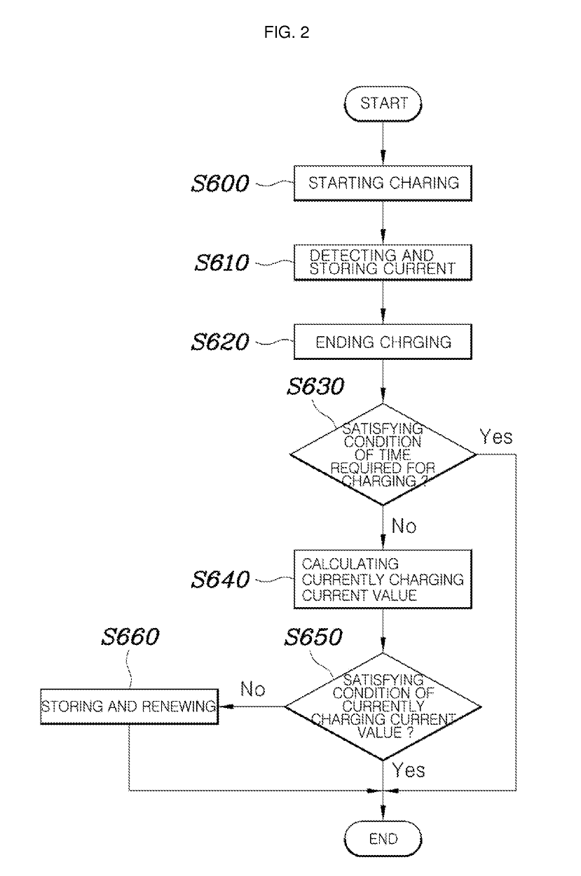

The reference current value refers to a current value stored in advance when a battery was previously charged. Referring to FIG. 2, the reference current value stored is renewed with the current value after charging of a vehicle is completed.

FIG. 2 shows renewing procedures of reference current value according to an embodiment of the present disclosure. When a charging of a vehicle starts S600, after the calculating step S210 to predict slowly charging time of a battery, the current when charging the vehicle is detected and stored per constant time interval S610. After charging of a vehicle is completed S620, it is determined whether the time required for the charging is out of a range of a time period set in advance S630. If the time required for charging of a vehicle is out of range, a currently charging current value of average current values detected during charging is calculated S640. The range of the set time period may be from about 3 to about 8 seconds.

After calculating the currently charging current value S640, it is determined whether the calculated currently charging current value is out of a set range S650. If the currently charging current value is out of the set range, the renewing step S660 is performed by storing the currently charging current value and renewing the existing reference current value with the currently charging current value. When the calculated currently current value is within the set range, the existing reference current value is maintained. The set range of current value may be from about 6 to about 10 ampere.

When the reference current value is renewed with the currently charging current value, the renewed currently charging current value is used as a reference current value for the next charging. If the reference current value is not renewed therewith, the reference current value that was previously stored is used for the next charging.

The time required for slowly charging a battery can be calculated by dividing the necessary charging amount by the reference current value. The necessary charging amount is achieved by multiplying time by amperes. The reference current value is given as amperes, and thus, the time required for slowly charging a battery can be obtained by dividing the necessary charging amount by the reference current value.

For rapid charging in the differentiating step S100, the method for predicting the charging time of a battery for an electric vehicle may further include a step of calculating the time required for rapidly charging the battery by detecting and inputting an initial temperature and initial SOC information of a battery S300 to a set map data S320.

In more detail, the initial temperature and the initial SOC information of a battery can be detected S300 through various detecting means such as a sensor or detecting logic set in a controller, etc. The detected values are input into the set map data as shown in Table 1 below and used for performing the calculating step S320.

The time required for rapidly charging a battery can be calculated per initial temperature from 0° C. to 45° C. and SOC state according to the map data as shown above.

The values between the respective temperatures and SOC states are varied linearly. For example, 2.5° C. can be exhibited between 0° C. and 5° C., and the time required for rapidly charging a battery at 5% of SOC can be calculated as 60 minutes, as a mean value of 55 and 65 minutes.

TABLE 1
Remaining time for charging per initial temperature/SOC(min)

| | [symbol] | | | | | | | |
|---|---|---|---|---|---|---|---|---|
| SOC | 0° C. | 5° C. | 10° C. | 13° C. | 15° C. | 25° C. | 40° C. | 45° C. |
| 5% | 65 | 55 | 46 | 30 | 24 | 24 | 24 | 28 |
| 10% | 60 | 91 | 42 | 29 | 21 | 21 | 21 | 25 |
| 15% | 56 | 48 | 40 | 28 | 19 | 19 | 19 | 23 |
| 20% | 52 | 45 | 38 | 27 | 18 | 18 | 18 | 20 |
| 25% | 48 | 42 | 35 | 26 | 16 | 16 | 16 | 18 |
| 30% | 44 | 40 | 33 | 25 | 15 | 15 | 15 | 16 |
| 35% | 39 | 38 | 31 | 23 | 13 | 13 | 13 | 14 |
| 40% | 35 | 34 | 29 | 22 | 12 | 12 | 12 | 12 |
| 45% | 30 | 30 | 27 | 18 | 10 | 10 | 10 | 11 |
| 50% | 26 | 26 | 25 | 15 | 9 | 9 | 9 | 9 |
| 55% | 22 | 21 | 21 | 13 | 7 | 7 | 7 | 8 |
| 60% | 17 | 17 | 17 | 10 | 6 | 6 | 6 | 6 |
| 65% | 13 | 13 | 13 | 8 | 5 | 5 | 5 | 5 |
| 70% | 9 | 9 | 9 | 6 | 4 | 4 | 4 | 4 |
| 75% | 4 | 4 | 4 | 3 | 2 | 2 | 2 | 2 |
| 80% | 1 | 1 | 1 | 1 | 1 | 1 | 1 | 1 |

If the detected initial temperature of a battery is not found within a range of temperature stored in the map data, the detecting step S200 and the calculating step S210 are performed. In other words, the time required for slowly charging a battery can be calculated at any temperature except for the temperatures in the map data. After, the initial temperature and SOC state of a battery are detected S300, the temperature value is compared within a range of the map data S310. If the temperature is included in the range of the map data, the calculation step S320 is performed using the map data, and if the temperature is not included in the range of the map data, the detecting step S200 and the calculation step S210 are performed to calculate the time required for slowly charging a battery.

According to a method for predicting a charging time of a battery for an electric vehicle, an accurate time can be predicted by using different logics for predicting the charging time in accordance with charging conditions, that is, a rapid charging or a slow charging.

In case of slow charging, since the previous charging data values are used, an accurate charging time can be predicted considering variations of the internal compositions and current values of a battery when charging the battery. Here, the variations of the internal compositions and current values of a battery affect the next charging with current values being increased or decreased by the variations at the next charging.

In case of rapid charging, the data map is used to further improve accuracy wherein more heat is produced, comparing to the slow charging, thus accelerating charging speed faster than the predicted time. Accordingly, an accurate prediction of charging time is possible through the data map considering in advance the variations that may occur.

While the disclosure is described in conjunction with exemplary embodiments, it is to be understood that present description is not intended to limit the disclosure to those exemplary embodiments. On the contrary, the present disclosure is intended to cover not only the exemplary embodiments, but also various alternatives, modifications, equivalents and other embodiments, which may be included within the spirit and scope of the disclosure as defined by the appended claims.

What is claimed is:

1. A method for predicting a charging time of a battery for an electric vehicle, comprising steps of:
differentiating a rapid charging and a slow charging;
calculating a necessary charging amount of a battery and detecting a reference current value that is stored in advance for the slow charging; and
calculating a time required for slowly charging a battery using the necessary charging amount and the reference current value.

2. The method for predicting a charging time of a battery for an electric vehicle of claim 1, wherein the differentiating step differentiates the rapid charging and the slow charging using different signals that are received when a charging connector contacts a vehicle.

3. The method for predicting a charging time of a battery for an electric vehicle of claim 1, wherein the necessary charging amount of a battery is estimated by calculating a difference between a total capacity of the battery and a capacity of the battery corresponding to a state of charge (SOC).

4. The method for predicting a charging time of a battery for an electric vehicle of claim 1, wherein the time required for slowly charging the battery is calculated by dividing the necessary charging amount by a current value of a previous charging.

5. The method for predicting a charging time of a battery for an electric vehicle of claim 1, further comprising a renewing step of storing a currently charging current value and renewing an existing reference current value with the currently charging current value, when the currently charging current values of average current values that are detected during charging are calculated and the calculated currently charging current values are out of a set range while completing the charging of a vehicle after the calculation step to predict slowly charging.

6. The method for predicting a charging time of a battery for an electric vehicle of claim 5, wherein the renewing step is not performed when the time required for charging the vehicle is within a range of set time.

7. The method for predicting a charging time of a battery for an electric vehicle of claim 1, further comprising a step of calculating the time required for rapidly charging the battery by detecting and inputting an initial temperature and an initial SOC (State Of Charge) information of the battery to a set map data for the rapid charging at the differentiating step.

8. The method for predicting a charging time of a battery for an electric vehicle of claim 7, wherein the detecting step and the calculating step to predict slowly charging time are performed when the detected initial temperature of the battery is not included in a range of temperature stored in the map data.
